(19) United States
(12) Patent Application Publication
(10) Pub. No.: US 2005/0193533 A1
(43) Pub. Date: Sep. 8, 2005

(54) Snap hook having lockable gate

(76) Inventor: Vincent Chang, Taichung (TW)

Correspondence Address: Charles E. Baxley, ESQ., 90 John Street - 3rd floor, New York, NY, 10038, US

(21) Appl. No.: 10/795,162

(22) Filed: Mar. 3, 2004

(51) Int. Cl. F16B 45/00

(52) U.S. Cl. 24/601.4

(57) ABSTRACT

A snap hook includes an S-shape having a hook formed on one end of a shank and an eyelet on the other end, the hook includes a receiving end located close to a ridge of the shank to define a mouth between the receiving end of the hook and the ridge. A retaining device includes a gate having a head and rotatable relative to the shank between a closed position where the head is engaged with the receiving end of the hook and an open position where the head is disengaged from the receiving end of the hook. A latch may selectively lock the gate to the hook, to prevent the head of the gate from being rotated away from the receiving end of the hook inadvertently.

### BACKGROUND OF THE INVENTION

1. Field of the Invention

The present invention relates to a snap hook, and more particularly to a snap hook having a pivotal gate that may be locked to the snap hook and to be prevented from being opened inadvertently.

2. Description of the Prior Art

Typical snap hooks comprise a hook body including a mouth formed or defined between two ends, and a latch or gate pivotally attached to one of the ends of the hook body, and engageable with the other end of the hook body, in order to enclose the mouth of the hook body.

For example, U.S. Pat. No. 5,664,304 to Tambornino, and U.S. Pat. No. 5,913,349 to Westwood, III, disclose two of the typical snap hooks each comprising a latch or gate pivotally attached to one end of the hook body to enclose the mouth of the hook body, and to prevent objects from entering into a hook opening of the hook body.

However, the latch or gate is simply attached to the hook body with a pivotal attachment, but may not be solidly secured or locked to the hook body, such that the latch or gate may have a good chance to be disengaged from the mouth of the hook body, or to have the mouth of the hook body opened inadvertently, by such as children, such that various objects may also have a good chance to enter into the hook opening of the hook body inadvertently.

The present invention has arisen to mitigate and/or obviate the afore-described disadvantages of the conventional snap hooks.

### SUMMARY OF THE INVENTION

The primary objective of the present invention is to provide a snap hook including a pivotal gate that may be locked to the snap hook and to be prevented from being opened inadvertently.

In accordance with one aspect of the invention, there is provided a snap hook comprising an S-shaped body including a shank having a hook formed on one end and an eyelet on the other end thereof, the hook including a receiving end located close to a ridge of the shank to define a mouth between the receiving end of the hook and the ridge, a retaining device attached onto the shank, and including a gate pivoted to the body and having a head, and the gate being rotatable relative to the body between a closed position where the head is engaged with the receiving end of the hook and an open position where the head is disengaged from the receiving end of the hook, and a latch selectively locking the gate to the hook, to prevent the head of the gate from being rotated away from the receiving end of the hook inadvertently.

The latch includes a catch extended therefrom to engage with the hook, and to lock the gate to the hook, and to prevent the gate from being rotated relative to the hook. The hook includes a lock notch formed therein, to receive the catch of the latch, and to lock the gate to the hook. The lock notch of the hook is formed in the securing end of the hook.

The gate includes at least one arm, the latch includes at least one conduit formed therein to slidably receive the arm of the gate, and to slidably attach the latch to the gate. The latch includes at least one swelling extended therefrom to facilitate moving of the latch relative to the gate.

The eyelet includes a free end located close to the ridge of the shank to define a slit between the free end of the eyelet and the ridge, the retaining device includes a second gate pivoted to the body and having a head, and the second gate is rotatable relative to the eyelet of the body for engaging with the free end of the eyelet and for enclosing the slit of the eyelet. The gate includes a ring formed thereon for engaging onto the free end of the eyelet and for enclosing the slit of the eyelet of the body.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a snap hook in accordance with the present invention;

FIG. 2 is a perspective view of the snap hook;

FIG. 3 is a cross sectional view of the snap hook, taken along lines 3-3 of FIG. 2;

FIG. 4 is a cross sectional view similar to FIG. 3, illustrating the operation of the snap hook;

FIGS. 5, 6, 7 are exploded views similar to FIG. 1, illustrating the other arrangements or shapes of the latch of the snap hook;

FIG. 8 is an exploded views similar to FIGS. 1, 5-7, illustrating another structure of the latch of the snap hook;

FIG. 9 is an exploded views similar to FIGS. 1, 5-8, illustrating the other structure of the latch of the snap hook;

FIG. 10 is an exploded views similar to FIGS. 1, 5-9, illustrating a further structure of the latch of the snap hook; and

FIG. 11 is an exploded views similar to FIGS. 1, 5-10, illustrating a still further embodiment of the latch of the snap hook.

### DETAILED DESCRIPTION OF THE PREFERRED EMBODIMENT

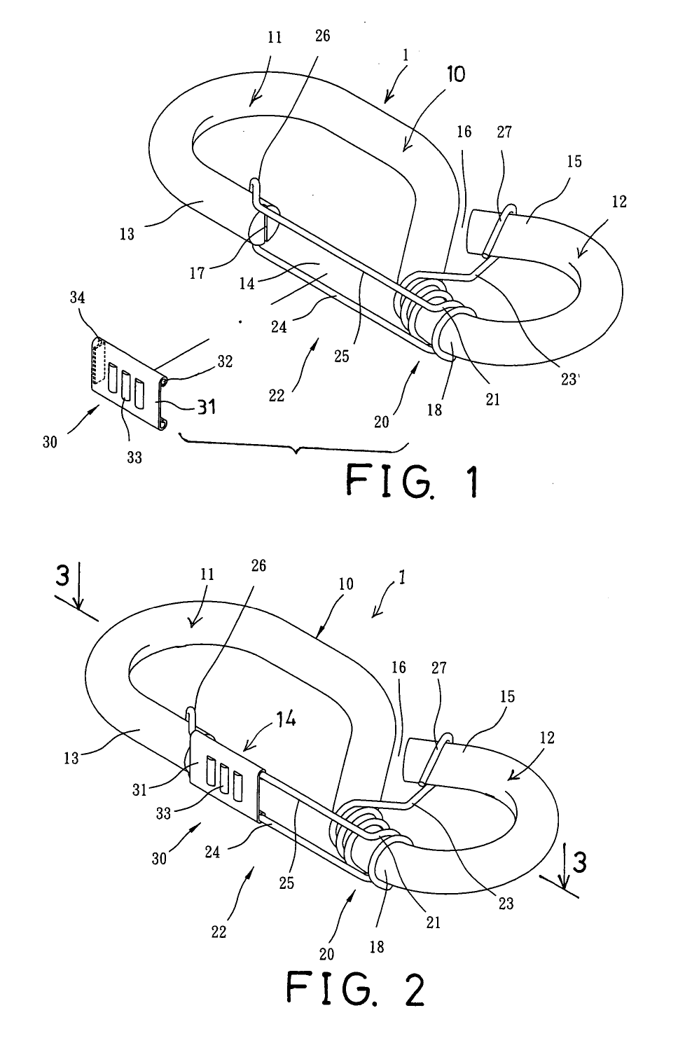

Referring to the drawings, and initially to FIGS. 1-5, a snap hook in accordance with the present invention comprises an S-shaped body 1 made of or formed with a single piece and round metal or steel rod having a generally S-shaped structure. The S-shaped body 1 includes a shank 10 having a hook 11 formed on one end thereof, and an engaging portion or eyelet 12 formed on the other end thereof.

The eyelet 12 is preferably a substantially closed circle that terminates at ridge 18 of the shank 10, and includes a free end 15 located close to the ridge 18 to form or define a slit 16 therebetween. The hook 11 of the body 1 includes a maximized interior space for allowing the hook 11 to accommodate the largest possible object in relation to the size of the eyelet 12, and includes a receiving end 13 located close to the ridge 18 to form or define a mouth 14 therebetween.

A retaining device 20 includes an intermediate portion 21 engaged or attached onto the ridge 18 of the shank 10, and includes one gate 22 resiliently formed or provided on one end thereof for engaging with the receiving end 13 of the hook 11 and for enclosing the mouth 14 of the hook 11. For example, the gate 22 of the retaining device 20 includes one or more, such as two arms 24, 25, and a head 26 formed or provided on one end thereof.

The gate 22 may be pivoted or rotated relative to the hook 11, and may be positioned to the hook 11 between a closed position where the head 26 is engaged with the receiving end 13 of the hook 11 and an open position where the head 26 is disengaged from the receiving end 13 of the hook 11.

The above-described structure of the snap hook device is typical and has been disclosed in the cited arts, and will not be described in further details. For example, U.S. Pat. No. 5,913,349 to Westwood, III discloses one of the typical snap hook device and is thus taken as a reference for the present invention.

The snap hook in accordance with the present invention comprises a latch 30 including a plate 31 slidably engaged onto the gate 20, and includes one or more, such as two conduits 32 formed or provided therein to slidably receive the arms 24, 25 of the gate 20, and to allow the latch 30 to be slid along the gate 20. The latch 30 includes one or more swellings 33 extended upwardly from the plate 31, to facilitate moving of the latch 30 relative or along the gate 20.

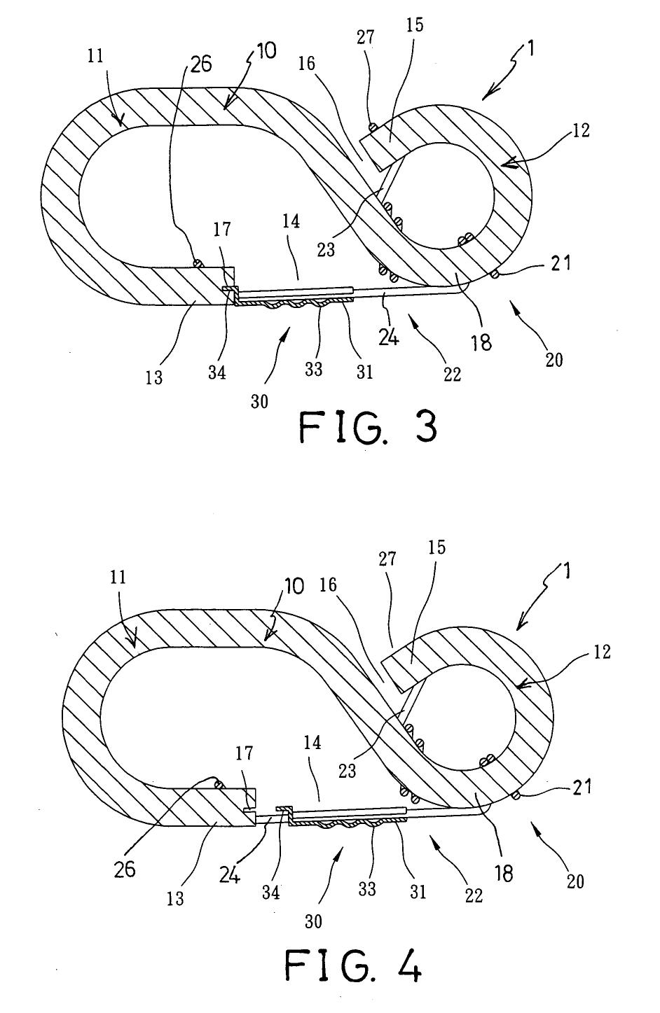

The body 1 includes a lock notch 17 formed in the receiving end 13 of the hook 11. The latch 30 includes a catch 34 extended therefrom for engaging into the lock notch 17 of the hook 11, and thus to lock the gate 20 to the hook 11 (FIGS. 2, 3). The gate 20 may be released and opened relative to the hook 11 when the catch 34 of the latch 30 is disengaged from the lock notch 17 of the hook 11 (FIG. 4).

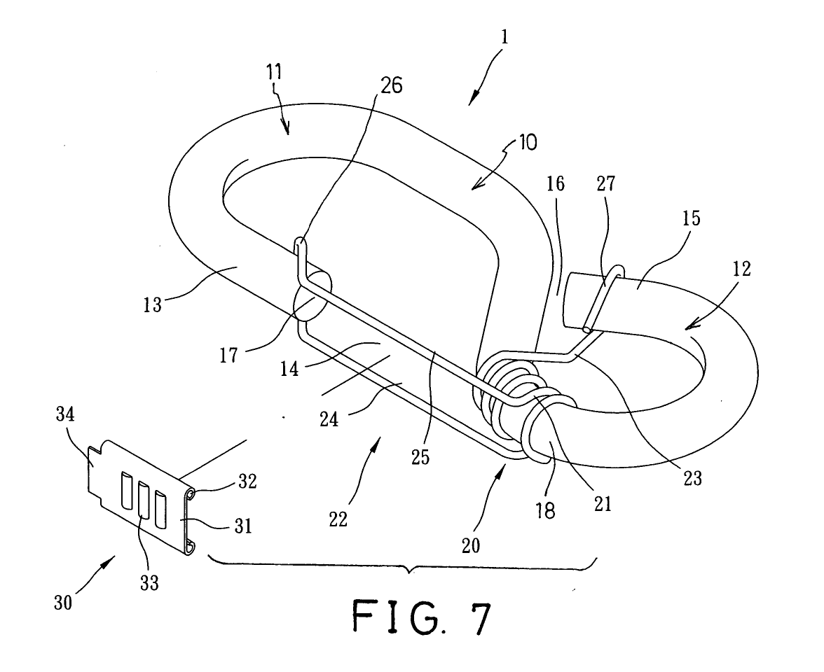

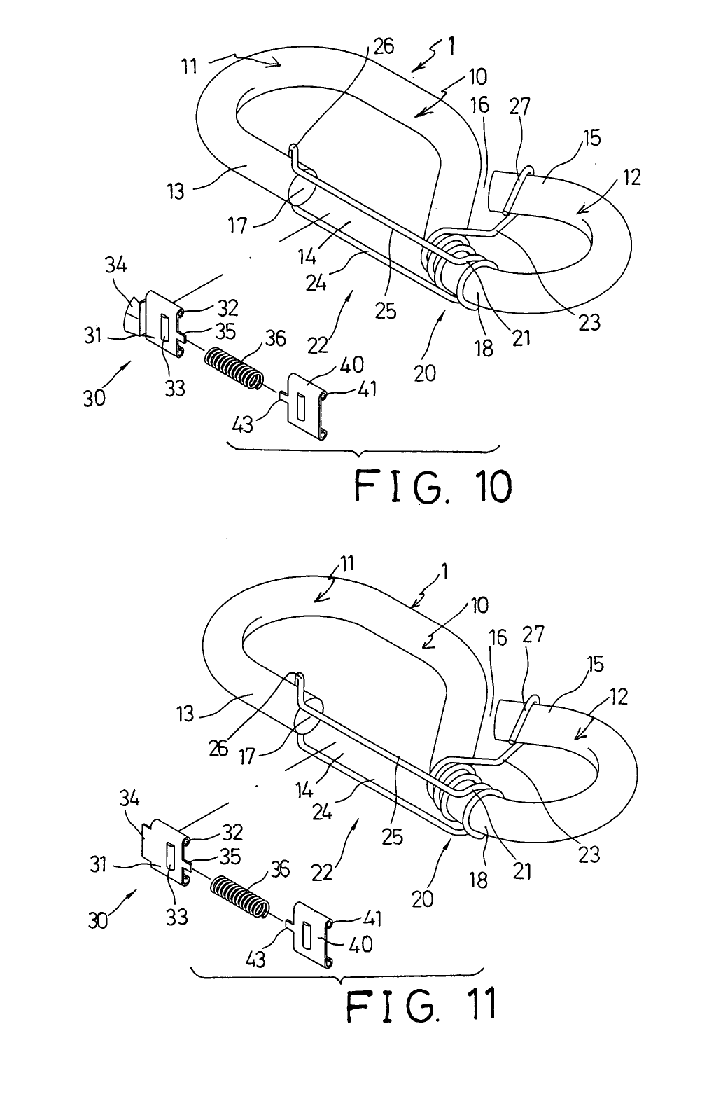

As shown in FIGS. 1-12, the retaining device 20 may further include another gate 23 resiliently formed or provided on the other end thereof and rotatable relative to the eyelet 12 of the body 10, for engaging with the free end 15 of the eyelet 12 and for enclosing the slit 16 of the eyelet 12. For example, the gate 23 includes a ring 27 formed or provided on the free end thereof for engaging onto the free end 15 of the eyelet 12 and for enclosing the slit 16 of the eyelet 12.

In operation, as shown in FIG. 3, when the catch 34 of the latch 30 is engaged into the lock notch 17 of the hook 11, the gate 20 may be locked to the hook 11 and may be prevented from being rotated relative to the hook 11, such that the head 26 of the gate 20 may not be rotated away from the receiving end 13 of the hook 11, and such that the mouth 12 of the hook 11 may not be opened inadvertently.

As shown in FIG. 4, when the latch 30 is moved away from the receiving end 13 of the hook 11, the catch 34 of the latch 30 may be disengaged from the lock notch 17 of the hook 11, and the gate 20 may be unlocked from the hook 11 and may be rotated relative to the hook 11, to allow the head 26 of the gate 20 to be rotated away from the receiving end 13 of the hook 11, and thus to open the mouth 12 of the hook 11.

Accordingly, the mouth 12 of the hook 11 may only be opened when the latch 30 is moved away from the receiving end 13 of the hook 11 and when the catch 34 of the latch 30 is disengaged from the lock notch 17 of the hook 11, such that the mouth 12 of the hook 11 may not be opened inadvertently by such as children, or by hitting or striking against the hook 11.

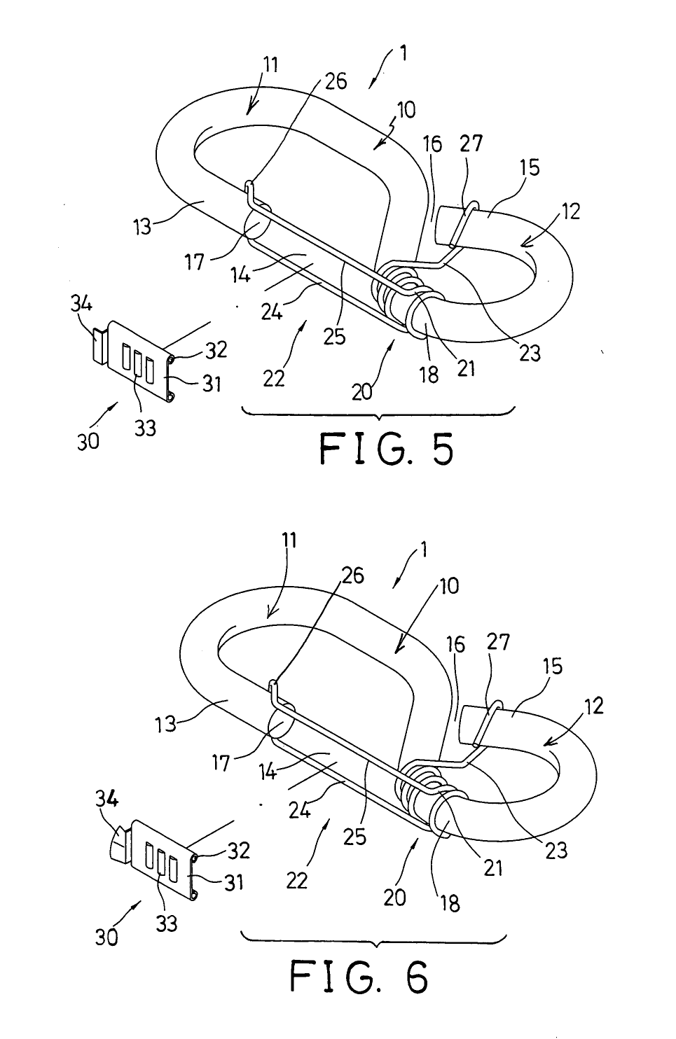

As shown in FIGS. 5-7, the catch 34 of the latch 30 may be extended from the latch 30 toward different positions or directions, and may be formed into various kinds of shapes, for directly engaging onto the receiving end 13 of the hook 11, without the formation or provision of the lock notch 17 in the hook 11.

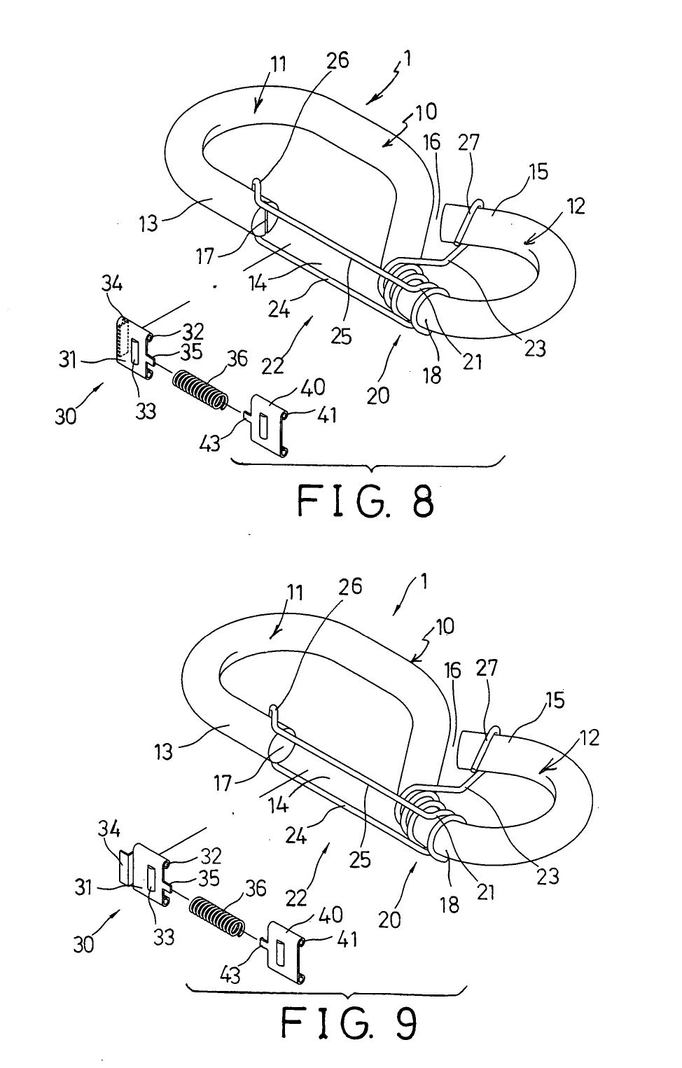

Alternatively, as shown in FIGS. 8-11, the latch 30 may further include a seat 40 having one or more, such as two conduits 41 formed or provided therein to slidably receive the arms 24, 25 of the gate 20, and to allow the seat 40 to be slid along the gate 20. The seat 40 and the plate 31 each includes a finger 43, 35 extended therefrom, for engaging with a spring 36 which may bias and force the catch 34 of the latch 30 to either engage into the lock notch 17 formed in the receiving end 13 of the hook 11 (FIG. 8), or to directly engage onto the receiving end 13 of the hook 11 (FIGS. 9-11), without the formation or provision of the lock notch 17 in the hook 11.

Accordingly, the snap hook in accordance with the present invention includes a pivotal gate that may be locked to the snap hook and to be prevented from being opened inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A snap hook comprising:
an S-shaped body including a shank having a hook formed on one end and an eyelet on the other end thereof,
said hook including a receiving end located close to a ridge of said shank to define a mouth between said receiving end of said hook and said ridge,
a retaining device attached onto said shank, and including a gate pivoted to said body and having a head, and said gate being rotatable relative to said body between a closed position where said head is engaged with said receiving end of said hook and an open position where said head is disengaged from said receiving end of said hook, and
a latch selectively locking said gate to said hook, to prevent said head of said gate from being rotated away from said receiving end of said hook inadvertently.

2. The snap hook as claimed in claim 1, wherein said latch includes a catch extended therefrom to engage with said hook, and to lock said gate to said hook, and to prevent said gate from being rotated relative to said hook.

3. The snap hook as claimed in claim 2, wherein said hook includes a lock notch formed therein, to receive said catch of said latch, and to lock said gate to said hook.

4. The snap hook as claimed in claim 3, wherein said lock notch of said hook is formed in said securing end of said hook.

5. The snap hook as claimed in claim 1, wherein said gate includes at least one arm, said latch includes at least one conduit formed therein to slidably receive said at least one arm of said gate, and to slidably attach said latch to said gate.

6. The snap hook as claimed in claim 1, wherein said latch includes at least one swelling extended therefrom to facilitate moving of said latch relative to said gate.

7. The snap hook as claimed in claim 1, wherein said eyelet includes a free end located close to said ridge of said shank to define a slit between said free end of said eyelet and said ridge, said retaining device includes a second gate pivoted to said body and having a head, and said second gate is rotatable relative to said eyelet of said body for engaging with said free end of said eyelet and for enclosing said slit of said eyelet.

8. The snap hook as claimed in claim 1, wherein said gate includes a ring formed thereon for engaging onto said free end of said eyelet and for enclosing said slit of said eyelet of said body.
